(19) United States
(12) Patent Application Publication
(10) Pub. No.: US 2026/0277471 A1
(43) Pub. Date: Sep. 17, 2026

(54) METHODS FOR CONTINUOUSLY WRITING RESILIENT DATA

(71) Applicant: Daedalus Cloud LLC, Croton-on-Hudson, NY (US)

(72) Inventors: Stuart John Inglis, Hamilton (NZ); Herbert Dennis Hunt, Darian, CT (US)

(21) Appl. No.: 19/471,631

(22) PCT Filed: Apr. 15, 2024
(86) PCT No.: PCT/US2024/024647

§ 371 Date: Oct. 1, 2025

Related U.S. Application Data
(60) Provisional application No. 63/497,204, filed on Apr. 19, 2023.

(51) Int. Cl. G06F 3/06

(52) U.S. Cl. CPC G06F 3/0656; G06F 3/0604; G06F 3/0689

(57) ABSTRACT

A method of writing data to a storage array comprising a plurality of storage devices, the method comprising: receiving a request to write data to the storage array; writing the received data to cache; commencing writing a first data block of a first data stripe from cache to a first storage device of the plurality of storage devices; commencing writing a second data block of the first data stripe to a second storage device of the plurality of storage devices; and commencing writing a first data block of a second data stripe to the first storage device after the first data block of the first data stripe has been written to the first storage device but before the second data block of the first data stripe has been written to the second storage device.

### RELATED APPLICATIONS

This application claims the priority benefit of U.S. Provisional Application 63/497,204, filed 19 Apr. 2023.

### FIELD OF THE INVENTION

The present invention relates to methods for continuously writing resilient data to a storage array.

### BACKGROUND

A storage system may comprise a storage array comprising a plurality of storage devices. Upon receiving a write request, a storage controller writes data to multiple storage devices in the storage array.

RAID (redundant array of independent disks) is a data storage scheme where data is stored on multiple (an array of) storage devices. RAID may be used to increase fault tolerance and/or to improve performance. A RAID scheme may be configured to different levels for different required levels of redundancy and performance. Standard RAID levels include RAID 0, RAID 1, RAID 2, RAID 3, RAID 4, RAID 5, and RAID 6. The more common RAID levels are RAID 0, RAID 1, RAID 5, and RAID 6. These RAID levels have a fixed layout.

### SUMMARY OF THE INVENTION

In a first example embodiment, there is provided a method of writing data to a storage array comprising a plurality of storage devices, the method comprising: receiving a request to write data to the storage array; writing the received data to cache; commencing writing a first data block of a first data stripe from cache to a first storage device of the plurality of storage devices; commencing writing a second data block of the first data stripe to a second storage device of the plurality of storage devices; and commencing writing a first data block of a second data stripe to the first storage device after the first data block of the first data stripe has been written to the first storage device but before the second data block of the first data stripe has been written to the second storage device.

Preferably, the method further comprises incrementing a pointer for the first storage device irrespective of any lag of the second storage device, the pointer being configured to indicate the next free physical location in the first storage device.

Preferably, the method further comprises sequentially writing to a next free physical location within a single storage device.

Preferably, the method further comprises updating a mapping between a logical address and a physical location.

Preferably, the method further comprises calculating a checksum.

Preferably, the cache is non-volatile cache.

Preferably, the method further comprises grouping the received data in cache by affinity.

Preferably, the method further comprises determining a lag of a lagging storage device in the storage array and classifying the lag as transient lag, pathological lag, or universal pathological lag.

Preferably, the method further comprises temporarily disabling one or more other storage devices in the storage array if the lag of the lagging storage device is transient lag.

Preferably, the method further comprises removing the lagging storage device from the storage array if the lag of the lagging storage device is pathological lag.

Preferably, the method further comprises generating an alert forecasting lags manifesting in one or more storage devices other than the lagging storage device.

Preferably, the method further comprises marking a part of the cache corresponding to the first data block as clean before marking a part of the cache corresponding to the second data block as clean.

Preferably, marking a part of the cache corresponding to the first data block as clean comprises: determining that the first data block has been written to a plurality of storage devices; and marking the part of the cache corresponding to the first data block as clean.

Preferably, marking a part of the cache corresponding to the first data block as clean comprises: determining that the first data block has been written to a subset of a plurality of storage devices; recording a transaction to copy the first data block from the subset of the plurality of storage devices to one or more other storage devices; and marking the part of the cache corresponding to the first data block as clean.

In a second example embodiment, there is provided one or more non-transitory computer readable media comprising instructions which, when executed by one or more processors, cause the one or more processors to perform the method of the first example embodiment.

In a third example embodiment, there is provided a computer program which, when executed by one or more processors, cause the one or more processors to perform the method of the first example embodiment.

### BRIEF DESCRIPTION OF THE DRAWINGS

The description is framed by way of example with reference to the drawings which show certain embodiments. However, these drawings are provided for illustration only, and do not exhaustively set out all embodiments.

FIG. 1 shows an example storage system.

FIG. 2 shows an example method of writing data to storage.

FIG. 3 shows a further example method of writing data to storage.

FIG. 4a shows a first example write progression.

FIG. 4b shows a second example write progression.

### DETAILED DESCRIPTION

An approach is described which may improve the process of writing data and increase both durability and resilience. Specifically, an improvement may be increased throughput when data stripes are written to a storage array comprising multiple storage devices.

The improvement may be achieved by continuously writing data (the continuous approach) from a new stripe to a storage device, disregarding lag experienced by any other storage devices. This contrasts a write method where stripes are written to all storage devices in a stepwise manner in time, that is, write operations are synchronized such that all storage devices attempt to write a new stripe at substantially the same time (the synchronous approach). Such a synchronized approach may lower throughput in cases where one or more storage devices are lagging (e.g. due to write failures) since other storage devices will simply stay idle until the lagging storage devices have finished writing the current data stripe.

Lag may be defined as the lag of one storage device relative to the most leading storage device, or lag may be defined as the lag of one storage device relative to the average write progression of all storage devices.

### Storage System

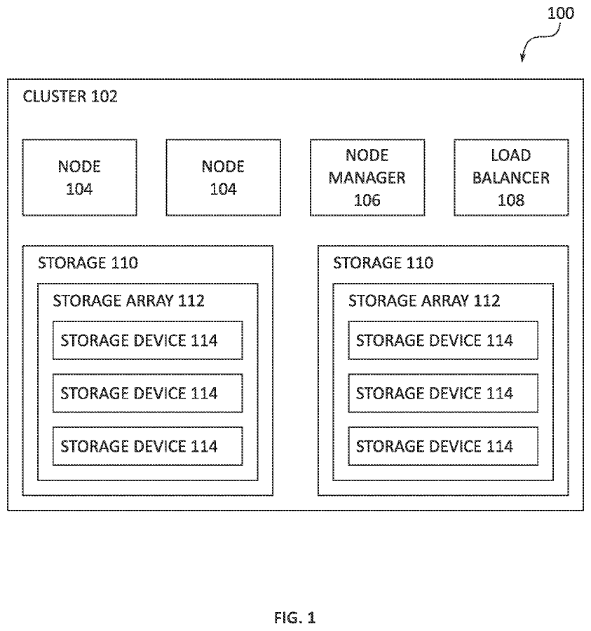

A storage system 100 may be constructed according to a wide range of topologies. A general example of the construction is shown in FIG. 1. The storage system 100 may be used to implement the methods described below.

The storage system 100 comprises one or more clusters 102. Each cluster comprises one or more nodes 104. Each node 104 is configured to receive requests to interact with data. For example, each node 104 may be configured to receive read or write requests. In a preferred case, each node 104 is able to access all data stored at the cluster. Consequently, each node 104 may maintain sufficient metadata to facilitate this. For example, each node 104 may maintain a metadata routing mapping to enable a logical location of data to be mapped to and from a physical location of data, and these mappings may be synchronized between the nodes.

Each node 104 may comprise one or more processors, a memory, and one or more peripherals. The processor, memory, and one or more peripherals may be interconnected via one or more data paths on a motherboard, via Infiniband, via Ethernet, or via any alternative technology.

Each node 104 may comprise a cache. In one example, the cache may be used as a write-back cache. In some cases, the cache can store data that is written or read which may improve the overall performance of the system. The cache may be implemented using memory. For example, this may involve the use of non-volatile memory alone or in combination with volatile memory. The non-volatile memory may be configured as non-volatile dual in-line memory module (NVDIMM). The cache may alternatively be implemented using non-memory storage. For example, the cache may be implemented using NVMe storage devices, Optane storage devices, CXL, or any other storage devices in the system. The cache is preferably non-volatile. This means that data stored in the cache is not lost when the cache loses power.

A cluster may have a node manager 106 configured to manage the nodes. For example, the node manager 106 may facilitate synchronizing the state of the nodes. In some cases, the node manager 106 is one of the nodes 104.

Additionally or alternatively, a load balancing node 108 may be provided to distribute incoming requests among the nodes 104. In one example, this may be based on the optimization of a performance metric, which may be read and/or write throughput or latency. This can ensure that a single node does not receive too many requests that would reduce the performance of the node 104 or the cluster in responding to requests. In other examples, this may reflect cluster capacities, data locality, security groups, or any of a number of alternative characteristics. In some cases, the load balancing node 108 may be the node manager 106 and/or a node 104.

Each node 104 is in communication with data storage 110. The data storage 110 represents the total storage space in the storage system 100. The data storage 110 can be organized into multiple levels.

In a first level, the data storage 110 comprises one or more storage arrays 112 which are configured to operate together. For example, a storage array 112 may comprise a storage enclosure.

In a second layer, each storage array 112 comprises one or more individual storage devices 114. For example, a storage device may be a hard disk storage device, solid state storage device utilizing flash or other persistent memory, or flash storage device. In preferred cases, each storage device 114 in a storage array 112 is the same size, since in some cases all storage devices 114 operate as if they are the size of the smallest storage device 114 in the storage array 112.

In some cases, the storage array 112 may not be a physical enclosure. In some cases, the storage array 112 may be virtual, where the individual storage devices 114 are accessible over a network (such as a mesh) and may be located in different locations.

In a third layer, each storage device 114 is divided into a plurality of blocks; that is, each storage device 114 is a block storage device. In preferred cases, each block in a storage device 114 is the same size, and preferably each block in each storage device 114 in the storage array 112 is the same size.

In some cases, different storage arrays 112 and/or different storage devices 114 may be of different types. For example, the different storage arrays 112 and/or different storage devices 114 may be tiered based on performance, cost, or other characteristics. For example, a first storage array and/or storage device may have a relatively fast read performance, and a second storage array and/or storage device may have a relatively slow read performance. In some cases, one or more of the storage devices 114 may be an object store, such as a cloud-based cold store. This may be beneficial to allow data to be stored appropriately in view of how it may be used. That is, data which is frequently accessed or updated may be kept on the relatively fast storage array and/or storage device. In an alternative embodiment, one or more of the storage devices 114 may be an object store.

In use, each node 104 may act as a storage controller by directly interfacing with data storage 110. The node 104 as storage controller may implement this by running a driver on its processor. The driver may be a long-running kernel which receives instructions to retrieve or store data. The storage controller can then interface directly with each of the one or more storage arrays 112 and perform any necessary computations, such as encoding or decoding, encrypting or decrypting, compression or decompression, deduplicating, or logging.

### Write

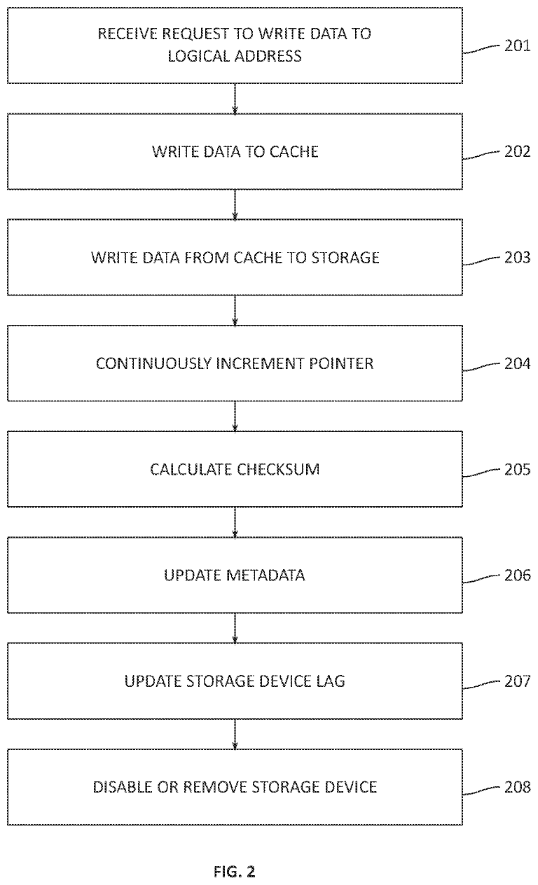

FIG. 2 shows an example method 200 for how a write request is handled.

At step 201, a request is received to write specified data to a logical address.

At step 202, the data is written to cache, which is preferably non-volatile cache. Once written to a non-volatile cache or a predetermined number of non-volatile caches, the data can be considered to have been successfully stored. This is due to the non-volatile nature of non-volatile cache which means the data will not be lost in the event of a power failure. The system may report the write request as being successfully fulfilled. As long as the non-volatile cache is not full, this provides extremely fast write performance.

In some cases, data in the non-volatile cache may have been received from many different sources. For example, in a multi-threaded context, each thread may write its own data. This means that two pieces of data received sequentially in time may be unrelated.

To mitigate this, data in the cache may be grouped in the cache by affinity. An affinity is an indication of the relationship of the data to other data. The purpose of the affinity is to indicate a likelihood that the two pieces of data are likely to be read at the same time. In one example, the affinity is calculated based on the logical address. Two pieces of data which have sequential logical addresses could have the same affinity since it is likely they would be read sequentially.

Alternatively, the affinity may be calculated as a function of one or more of:
the logical address;
the time at which the request was received;
a process identifier of the process which issued the request to write data;
a processor identifier of the processor executing the process which issued the request to write data; and
a processor core identifier of the core of the processor executing the process which issued the request to write data.

At step 203, the data may subsequently be written from the non-volatile cache to storage.

A process of eviction may be triggered when the non-volatile cache becomes sufficiently full, if the load on the system is low enough that maintenance operations such as cache eviction can be performed, or if the system otherwise determines that eviction would improve overall performance.

Data is placed into stripes across multiple storage devices. Depending on the size of the stripe, this can require the data from multiple write requests to be bundled together to provide sufficient data. Thus, the data may be retained in the non-volatile cache until enough data has been received.

With respect to the placement of blocks on each storage device, writing occurs in a predetermined manner, according to preferred characteristics. In one example, within a single storage device, writing occurs sequentially. That is, each storage device writes monotonically in order irrespective of the logical address provided in the command. This improves the overall write performance. More generally, the system may use any other pattern placement logic that the system determines would result in the preferred performance characteristics.

In particular, the system writes a stripe to a plurality of storage devices based on a pointer which corresponds to a physical location of each storage device. The pointer represents the next free block of each storage device. A free block is a block in which no data is stored, or if data is stored, there is no need for that data to be retrievable. In this way, the block is appended to the sequence of blocks which have already been written. At each clocked write, each of the plurality of storage devices attempts to write the data at the location indicated by the pointer. The attempt may be successful, in which case the pointer is then incremented to the next free location. Or the attempt may be unsuccessful, in which case a further attempt is made to write the same data to the same location at the next clocked write.

The system writes a stripe to a plurality of storage devices substantially in parallel. In practice, there will be a random seek and settle time associated with each individual storage device of the plurality of storage devices. This reflects the randomness of where the head is positioned on each storage device relative to the physical location indicated by the pointer. It is highly unlikely that all writes to the plurality of storage devices will complete at the same time, though assuming that all writes are successful on the first attempt in an ideal case, the discrepancies will not exceed the time it takes for a head to complete a full revolution on a storage device.

It may be the case, however, that a write to a storage device of the plurality of storage devices may require multiple attempts to succeed or have some delay due to the communications bus. This may be due to degradation of the storage device, or due to the total throughput on the bus. For each additional attempt, the head will have to complete a full revolution, which adds to the total time taken to successfully write to that storage device. In that case, that specific storage device can be said to be lagging behind in write progression compared to other storage devices of the storage array. In general, the lag for a given storage device may be modeled as the sum of the seek time (random but upper-bounded) and an integer (number of attempts, which is not upper-bounded) multiple of the time required for the head to complete a full revolution along with communication bus latencies.

The system may deal with the latencies associated with each storage device in a number of ways.

A first example embodiment uses a synchronous approach, where new stripes are written synchronously in a stepwise manner in time. For example, the system checks whether all data blocks in the present stripe have been successfully written to their respective storage devices at each clocked write, and it is only when the check returns true that the pointer is incremented to the next free location for each storage device. In other words, the pointers for the plurality of storage devices are synchronously incremented. In this example embodiment, a lagging storage device impedes the write progression of other storage devices as those cannot begin to write the next stripe (they remain idle) until the lagging storage device has finished writing its data block of the present stripe. This may be somewhat helped by multiple parallel write streams writing to multiple stripes.

A preferred embodiment uses a continuous approach. The pointer for each storage device that has successfully completed a write of the current stripe is incremented at step 204 irrespective of whether any other storage devices are lagging or how much they are lagging (within an allowable range).

In this way, an improvement in throughput may be achieved by continuously writing a new stripe (or reattempting to write the present stripe) to all storage devices; no storage device remains idle. While writes still occur substantially in parallel in a striped manner, the pointers for the plurality of storage devices are not incremented strictly in sync at the striped level. At a given clocked write, the pointer for a storage device may be incremented to the next free block so it may begin to write a new stripe if its last write attempt was successful, while the pointer for a lagging storage device will remain unchanged if its latest write attempt was unsuccessful.

In some cases, the lag may fall outside an allowable range. The allowable range may be in terms of time (and the resultant use of non-volatile cache) or parity. Where this occurs, the pointer may not be incremented until the lag falls back to the allowable range or the storage device responsible for the lag is removed.

By writing to a next free block (which, by definition, is free), there is no need to determine whether the data at the indicated block has changed. This avoids the need to initially read from the block, and therefore can result in improved throughput.

Moreover, because the physical location need not be correlated with the logical address, there is no need for the system to determine where the next free block is to achieve this. This minimizes an overhead which may otherwise occur during writes.

The data may be written to storage according to affinity. For example, it may be that the cache holds data which has sequential logical addresses, even though the data was written to the cache non-sequentially. Based on this, the system may write that data to storage sequentially based on the sequential logical address. This acts to defragment the data in the cache as part of the writing process. Consequently, a subsequent read for the same data may execute relatively quickly, compared to if the data had been written to storage in the same order that the system received the write requests.

Data corresponding to one or more storage devices of a storage array may be marked as clean in cache (meaning the part of the cache storing that data is now free to be written over with new data) before other data of the same stripe is marked as clean. Preferably, data eviction occurs with respect to each individual storage device such that data corresponding to one data block in a stripe may be marked as clean (thereby evicted) as soon as that data block has been successfully written to a storage device.

In cases where written data is mirrored to two or more drives, the data may be retained in the cache until it has been written to each of the two or more drives. In such a case, the cache may be marked as clean only after the data has been written to each of the two or more drives.

Alternatively, where written data is mirrored to two or more drives and it has been successfully written to a subset of the two or more drives (for example, at least half of the two or more drives or a predetermined number of the predetermined drives), a transaction may be logged to copy the data from the subset of the two or more drives to the remaining of the two or more drives. This allows the mirroring to be completed without extensive use of non-volatile cache.

At step 205, a checksum for the data at the block indicated by the physical location is calculated. The checksum may be a cryptographic hash or any other appropriate algorithm. This can be used to verify that data subsequently retrieved from the block is the same as the data stored at the block. In some cases, the checksum may comprise parity information which can correct some errors in the block. In some cases, this step may be omitted.

At step 206, metadata for the persistent storage device is updated.

The metadata comprises a mapping from the logical address to the physical address. This links the logical address (which the requestor or another process can use to indicate the intended data to be retrieved) to the physical location (where the actual data is stored). The metadata further comprises the checksum for each block (if calculated). A further cache for metadata indirection may be used to decrease metadata lookup latency.

The metadata may further comprise a flag for whether a write attempt was successful for a given storage device. Setting a flag can avoid overwriting correctly written data in an idling storage device at the next clocked write in the synchronous approach.

Optionally at step 207, the lag for each storage device is recorded (updated). A determination is made as to the nature of the lag of one or more lagging storage devices. The determination may be made by a trained machine learning model. The nature of the lag may be classified according to four cases.

In a first case, it is determined that the lag of a lagging storage device is caused primarily by random seek times (lag contribution from failed writes is within an expected range). This kind of lag may be regarded as device transient lag.

In a second case, it is determined that the lag of a lagging storage device is caused primarily by long-term degradations and/or a short-term fault in the lagging storage device. This kind of lag may be regarded as pathological lag as the lag is causatively related to a pathological defect in the lagging storage device as opposed to probabilistic variance e.g. randomness of seek times.

In a third case, it is determined that the lag of a lagging storage device is caused primarily by long-term degradations and/or a short-term fault in the overall storage system. This kind of lag may be regarded as universal pathological lag. Universal pathological lag may initially manifest in a few storage devices but will over time manifest in all storage devices.

In a fourth case, it is determined that the lag of a lagging storage device is caused primarily by variation in devices across the communication bus. This kind of lag may be regarded as bus transient lag.

Optionally at step 208 (conditional on step 207), storage devices are selectively disabled or removed from the storage array. If the lag were determined to be transient lag at step 207, the storage devices that are leading the lagging storage device may be temporarily disabled such that no new data is written to those leading storage devices. The leading storage devices may continue to remain disabled until the lag of the lagging device has fallen below a predetermined threshold. If the lag were determined to be pathological lag at step 207, the lagging storage device may be removed from the storage array, which may result in increased overall performance. If the lag were determined to be universal pathological lag at step 207, then the lagging storage device may be kept in operation since removing the storage device will likely not prevent the universal pathological from manifesting in other storage devices. An alert may be generated to forecast the possibility of future lags manifesting and/or worsening in more storage devices in the system.

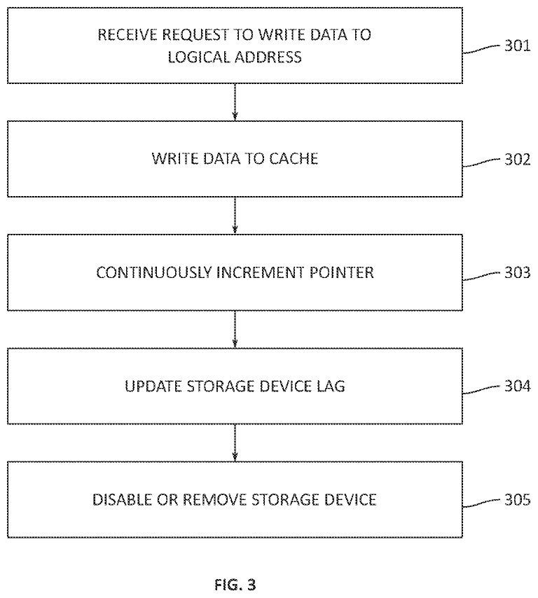

FIG. 3 shows a further example method 300 for how a write request is handled.

At step 301, a request is received to write specified data to a logical address.

Optionally at step 302, the data is written to cache, which is preferably non-volatile cache. Once written to non-volatile cache, the data can be considered to have been successfully stored. This is due to the non-volatile nature of non-volatile cache which means the data will not be lost in the event of a power failure. The system may report the write request as being successfully fulfilled. As long as the non-volatile cache is not full, this provides extremely fast write performance.

At step 303, data is continuously written in stripes across multiple storage devices. The striped writes may be performed based on a pointer which corresponds to a physical location of each storage device. At each clocked write, each of the plurality of storage devices attempts to write data at the location indicated by the pointer. The attempt may be successful, in which case the pointer is then incremented to the next free location. Or the attempt may be unsuccessful, in which case a further attempt is made to write the same data to the same location at the next clocked write.

The system writes a stripe to a plurality of storage devices substantially in parallel. In practice, there will be a random seek time associated with each individual storage device of the plurality of storage devices. This reflects the randomness of where the head is positioned on each storage device relative to the physical location indicated by the pointer. It is highly unlikely that all writes to the plurality of storage devices will complete at the same time, though assuming that all writes are successful on the first attempt in an ideal case, the discrepancies will not exceed the time it takes for a head to complete a full revolution on a storage device.

It may be the case, however, that a write to a storage device of the plurality of storage devices may require multiple attempts to succeed. This may be due to degradation of the storage device. For each additional attempt, the head will have to complete a full revolution, which adds to the total time taken to successfully write to that storage device. In that case, that specific storage device can be said to be lagging behind in write progression compared to other storage devices of the storage array. In general, the lag for a given storage device may be modeled as the sum of the seek time (random but upper-bounded) and an integer (number of attempts, which is not upper-bounded) multiple of the time required for the head to complete a full revolution.

If the optional step 302 were performed, then step 303 would occur as a cache eviction step. Data corresponding to one or more storage devices of a storage array may be marked as clean in cache (meaning the part of the cache storing that data is now free to be written over with new data) before other data of the same stripe is marked as clean. Preferably, data eviction occurs with respect to each individual storage device such that data corresponding to one data block in a stripe may be marked as clean (thereby evicted) as soon as that data block has been successfully written to a storage device.

In cases where written data is mirrored to two or more drives, the data may be retained in the cache until it has been written to each of the two or more drives. In such a case, the cache may be marked as clean only after the data has been written to each of the two or more drives.

Alternatively, where written data is mirrored to two or more drives and it has been successfully written to a subset of the two or more drives (for example, at least half of the two or more drives or a predetermined number of the predetermined drives), a transaction may be logged to copy the data from the subset of the two or more drives to the remaining of the two or more drives. This allows the mirroring to be completed without extensive use of non-volatile cache.

At step 303, the pointer for each storage device that has successfully completed a write of the current stripe is incremented irrespective of whether any other storage devices are lagging or how much they are lagging. In this way, an improvement in throughput may be achieved by continuously writing a new stripe (or reattempting to write the present stripe) to all storage devices; no storage device remains idle. While writes still occur substantially in parallel in a striped manner, the pointers for the plurality of storage devices are not incremented strictly in sync at the striped level. At a given clocked write, the pointer for a storage device may be incremented to the next free block so it may begin to write a new stripe if its last write attempt was successful, while the pointer for a lagging storage device will remain unchanged if its latest write attempt was unsuccessful.

Optionally at step 304, the lag for each storage device is recorded (updated). A determination is made as to the nature of the lag of one or more lagging storage devices. The determination may be made by a trained machine learning model. The nature of the lag may be classified according to four cases.

In a first case, it is determined that the lag of a lagging storage device is caused primarily by random seek times (lag contribution from failed writes is within an expected range). This kind of lag may be regarded as device transient lag.

In a second case, it is determined that the lag of a lagging storage device is caused primarily by long-term degradations and/or a short-term fault in the lagging storage device. This kind of lag may be regarded as pathological lag as the lag is causatively related to a pathological defect in the lagging storage device as opposed to probabilistic variance e.g. randomness of seek times.

In a third case, it is determined that the lag of a lagging storage device is caused primarily by long-term degradations and/or a short-term fault in the overall storage system. This kind of lag may be regarded as universal pathological lag. Universal pathological lag may initially manifest in a few storage devices but will over time manifest in all storage devices.

In a fourth case, it is determined that the lag of a lagging storage device is caused primarily by variation in devices across the communication bus. This kind of lag may be regarded as bus transient lag.

Optionally at step 305 (conditional on step 304), storage devices are selectively disabled or removed from the storage array. If the lag were determined to be transient lag at step 304, the storage devices that are leading the lagging storage device may be temporarily disabled such that no new data is written to those leading storage devices. The leading storage devices may continue to remain disabled until the lag of the lagging device has fallen below a predetermined threshold. If the lag were determined to be pathological lag at step 304, the lagging storage device may be removed from the storage array, which may result in increased overall performance. If the lag were determined to be universal pathological lag, then the lagging storage device may be kept in operation since removing the storage device will likely not prevent the universal pathological from manifesting in other storage devices. An alert may be generated to forecast the possibility of future lags manifesting and/or worsening in more storage devices in the system.

### EXAMPLE

An illustrative example is now described which compares the synchronous approach and the continuous approach for dealing with lags in individual storage devices in write operations.

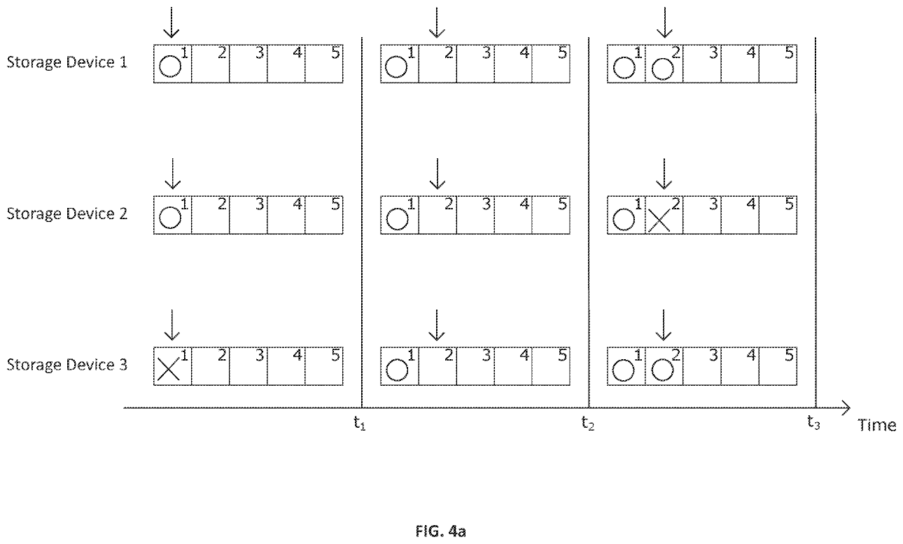

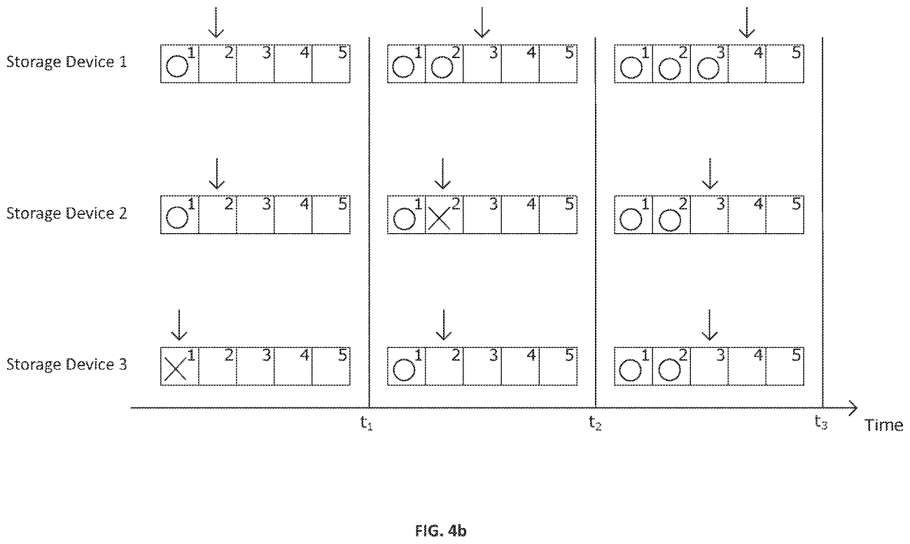

FIG. 4a shows the synchronous approach. FIG. 4b shows the continuous approach. Three storage devices are described for simplicity. In practice, a storage array would normally comprise more storage devices. Each storage device has five data block locations as shown, labeled one to five. A circle denotes a successful write attempt while a cross denotes a failed write attempt. An arrow is used to denote the position of the pointer. The time markers t1, t2 and t3 refer to sequential clocked writes.

At time t1, it is expected that one data block will have been written to each of Storage Device 1, Storage Device 2, and Storage Device 3 at Location 1, thereby completing a first data stripe. The attempts to write to Location 1 of Storage Device 1 and Storage Device 2 succeed. However, the attempt to write to Location 1 of Storage Device 3 fails. This causes Storage Device 3 to lag.

For the synchronous approach of FIG. 4a, the pointer for each Storage Device remains at Location 1 because Storage Device 3 has yet to finish writing the data block of the first stripe.

For the continuous approach of FIG. 4b, the pointer for Storage Device 3 remains at Location 1, but the pointers for Storage Device 1 and Storage Device 2 are incremented to Location 2. As described above, the continuous approach individually assesses whether each storage device has successfully completed the write for the current stripe irrespective of any failed attempts (lag) in other storage devices. The write attempts were successful in Storage Device 1 and Storage Device 2, so their pointers have been incremented to Location 2 notwithstanding the failed attempt in Storage Device 3.

The second attempt to write to Location 1 of Storage Device 3 is successful. This is shown in both FIGS. 4a and 4b as the cross has been replaced by a circle at Location 1 of Storage Device 3 by time t2.

For the synchronous approach of FIG. 4a, the pointers for all three Storage Devices are incremented to Location 2 in a synchronous manner. No further data blocks have been written to Storage Device 1 and Storage Device 2 as they have remained idle.

For the continuous approach of FIG. 4b, attempts have been made to write a second stripe to Storage Device 1 and Storage Device 2 at Location 2. The attempt to write to Location 2 of Storage Device 1 succeeds. The attempt to write to Location 2 of Storage Device 2 fails. The pointers for Storage Device 1 and Storage Device 3 are incremented to Location 3 and Location 2 respectively because the write attempts were successful. The pointer for Storage Device 2 remains at Location 2 because of the failed attempt.

In other words, the continuous approach has resulted in a data block of the second stripe being written to Storage Device 1 after successfully writing a data block of the first stripe to Storage Device 1 but before a data block of the second stripe has been written to Storage Device 3, which is lagging.

At time t3, data from the second stripe is successfully written to Storage Device 1 and Storage Device 3 at Location 2 for the synchronous approach. The attempt to write to Location 2 of Storage Device 2 fails, consistent with the write progression of the continuous approach.

At time t3, data from a third stripe is successfully written to Storage Device 1 at Location 3 for the continuous approach. Data from the second stripe is successfully written to Storage Device 3 at Location 2. Data from the second stripe is successfully written to Storage Device 2 at Location 2 in a re-attempt. Pointers for Storage Device 1, Storage Device 2, and Storage Device 3 are incremented to Location 4, Location 3, and Location 3, respectively.

Comparing the continuous approach with the synchronous approach, both approaches have each encountered two failed write attempts in the same time interval in the same manner: first at Location 1 of Storage Device 3 and then at Location 2 of Storage Device 2. By time t3, the example of FIG. 4a (synchronous approach) has finished writing the first stripe to storage. Contrastingly, the example of FIG. 4b (continuous approach) has finished writing the first and second stripes and partially written the third stripe to storage. The continuous approach may therefore offer improved write performance as greater throughput is achieved.

### Conclusion

Embodiments as described above allow for data to be written continuously (that is, without the temporary lag of one storage device necessarily delaying the writing of others) and when it is used in conjunction with increased parity and garbage collection and self-healing, it provides an improvement to conventional RAID which may be particularly beneficial for use in servers in high resilience and high durability situations.

Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

References to first, second, and third data stripes are meaningful in the sense that the ordinal numbers describe a sequential flow of data. For example, data in the second data stripe immediately follows data in the first data stripe in a data stream. The ordinal numbers do not merely distinguish arbitrary data stripes from one another.

1. A method of writing data to a storage array comprising a plurality of storage devices, the method comprising:
receiving a request to write data to the storage array;
writing the received data to cache;
commencing writing a first data block of a first data stripe from cache to a first storage device of the plurality of storage devices;
commencing writing a second data block of the first data stripe to a second storage device of the plurality of storage devices; and
commencing writing a first data block of a second data stripe to the first storage device after the first data block of the first data stripe has been written to the first storage device but before the second data block of the first data stripe has been written to the second storage device.

2. The method of claim 1, further comprising incrementing a pointer for the first storage device irrespective of any lag of the second storage device, the pointer being configured to indicate the a next free physical location in the first storage device.

3. The method of claim 1, further comprising sequentially writing to a next free physical location within a single storage device.

4. The method of claim 1, further comprising updating a mapping between a logical address and a physical location.

5. The method of claim 1, further comprising calculating a checksum.

6. The method of claim 1, wherein the cache is non-volatile cache.

7. The method of claim 1, further comprising grouping the received data in cache by affinity.

8. The method of claim 1, further comprising determining a lag of a lagging storage device in the storage array and classifying the lag as transient lag, pathological lag, or universal pathological lag.

9. The method of claim 8, further comprising temporarily disabling one or more other storage devices in the storage array if the lag of the lagging storage device is transient lag.

10. The method of claim 8, further comprising removing the lagging storage device from the storage array if the lag of the lagging storage device is pathological lag.

11. The method of claim 8, further comprising generating an alert forecasting lags manifesting in one or more storage devices other than the lagging storage device.

12. The method of claim 1, further comprising marking a part of the cache corresponding to the first data block as clean before marking a part of the cache corresponding to the second data block as clean.

13. The method of claim 12, wherein marking a part of the cache corresponding to the first data block as clean comprises:
determining that the first data block has been written to a plurality of storage devices; and marking the part of the cache corresponding to the first data block as clean.

14. The method of claim 12, wherein marking a part of the cache corresponding to the first data block as clean comprises:
determining that the first data block has been written to a subset of a plurality of storage devices;
recording a transaction to copy the first data block from the subset of the plurality of storage devices to one or more other storage devices; and
marking the part of the cache corresponding to the first data block as clean.
